(19) United States
(12) Patent Application Publication
(10) Pub. No.: US 2010/0236847 A1
(43) Pub. Date: Sep. 23, 2010

(54) Hybrid propulsion system

(75) Inventors: Anthony An-Tao Yang, Surrey (CA); An-Tao Anthony Yang, (US)

Correspondence Address: Anthony An-Tao Yang, 16776 - 108 Ave., Surrey, BC, V4N 1M4, CA

(73) Assignees: Anyhony An-Tao Yang, Surrey (CA); Aleees Eco Ark (Cayman) Co. LTD., Grand Cayman (KY)

(21) Appl. No.: 12/659,673

(22) Filed: Mar. 17, 2010

Related U.S. Application Data
(60) Provisional application No. 61/210,222, filed on Mar. 17, 2009.

(51) Int. Cl. B60K 6/42

(52) U.S. Cl. 180/65.22; 180/65.21

(57) ABSTRACT

A hybrid system having an engine, a motor, a transmission, a clutch connecting the engine and the transmission, and a continuously variable transmission connecting the motor and the transmission is provided

### CROSS-REFERENCE TO RELATED APPLICATIONS

This application claims priority to U.S. application Ser. No. 61/210,222, filed on Mar. 17, 2009. The disclosure of the prior application is considered part of (and is incorporated by reference in) the disclosure of this application.

### BACKGROUND

Since the invention of automobile, the fossil fuel has been the major source of the energy required to propel the vehicle; however, the climate change and the increase of crude oil price have lead to the development of energy efficient vehicles.

Hybrid electric vehicle is currently the most common solutions in producing fuel efficient vehicles, which includes many different configurations utilized by different car companies. Hybrid electric vehicles are capable of shut off the engine while the vehicle is stationary; thus, engine accessories such as: air conditioning compressor, power steering pump, and water pump has to be replaced with electrically driven unit. This design change partially contributed to the increased in cost of hybrid electric vehicles.

Another issue for hybrid electric vehicles is space. Due to the need to place electric machines in proximity of the engine, a volume must be provided for the electric machine; usually by decreasing the size of engine, redesign the transmission to incorporate the electric machines, or increase the size of the hood area. These methods caused some mandatory design changes to the hybrid electrical which also increased the cost.

Parallel hybrid systems on the market are limited to continuously variable transmission; however, not all drivers prefer continuously variable transmission; this is also a major reason which affected the implementation of hybrid vehicle.

### OBJECTIVE

The primary objective is to provide a hybrid propulsion system for vehicle.

The secondary objective is to provide a hybrid propulsion system adaptable to current engine accessories.

### SUMMARY

A hybrid system has an engine, a motor, a transmission, a clutch connecting the engine and the transmission, and a continuously variable transmission connecting the motor and the transmission.

### DESCRIPTION OF THE DRAWING

FIG. 1 is an exploded perspective view of a first embodiment consistent with the present invention.

FIG. 2 is an exploded perspective view of a second embodiment consistent with the present invention.

### DESCRIPTION

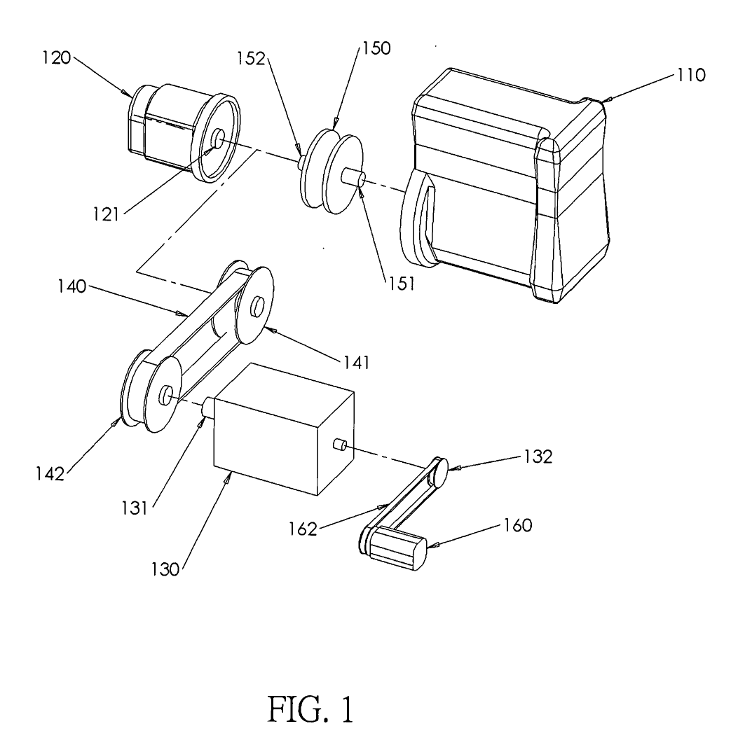

In a first embodiment consistent with the principles of the present invention, as shown in FIG. 1, the output shaft (not shown) of engine 110 is connected to the engine-side shaft 151 of the clutch 150. The transmission-side shaft 152 of the clutch 150 is connected to the input shaft 121 of the transmission 120. The transmission 120 mentioned herein is a complete transmission; if a manual transmission is used, a clutch would be included within the transmission casing, and if an automatic transmission is used, a torque converter would be included within the transmission casing. The rotor shaft 131 of the motor 130 is connected to motor-side pulley 142 (also known as the first shaft) of the continuously variable transmission 140. The transmission-side pulley 141 (also known as the second shaft) of the continuously variable transmission 140 is connected to the input shaft 121 of the transmission 120. An accessory pulley 132 is connected to the rotor shaft 131 of the motor 130. A belt 162 is connecting the accessory pulley 132 and accessory 160; accessory 160 mentioned herein represents any accessory that is used in automotive such as air conditioning compressor, power steering pump, water pump, air pump, vacuum pump or other accessories. A control system (not shown) is provided to control the clutch 150, the engine 110, and the motor 130.

If a manual transmission or an automatic transmission is used as the transmission 120, the motor 130 is to be used in torque control mode. The maximum operational rpm for the motor 130 to provide torque is predetermined as n1. The minimum operational rpm for the motor 130 to power the accessory 160 is predetermined as n4. Two other rpm n2 and n3 are also predetermined between n1 and n4 wherein n2 is greater than n3.

Before user steps on the accelerator pedal, the rpm of motor 130 is maintained above n4. The clutch 150 is released thus disconnecting the engine-side shaft 151 and the transmission-side shaft 152. The engine 110 may be stopped to conserve fuel. The accessory 160 is powered by motor 130 via the belt 162 and accessory pulley 132.

When user steps on the accelerator pedal, the pedal angle is translated into a motor torque control signal which specifies the amount of torque that motor 130 should provide. As the motor 130 generates torque, the rpm of the motor 130 increases. When the rpm exceeds n2, the continuously variable transmission 140 will change the ratio to provide more load on the motor-side pulley 142 thus decrease the rpm of the motor 130. If the rpm exceed n1, the torque of the motor 130 will be set to zero, and no longer generates torque. If the rpm of the motor 130 decrease below n3, the continuously variable transmission 140 will also change to decrease the load on the motor-side pulley 142 to decrease the load thus increase the rpm of the motor 130.

If the torque demanded by the user exceeds the ability of the motor 130, the system will enter hybrid mode, which both the engine 110 and the motor 130 will be used to provide torque. The clutch 150 will engage in a controlled manner, which spins the output shaft of the engine 110 and starts the engine 110.

During high speed cruise, the system will enter engine mode. The engine 110 will be used to provide torque. During engine mode, the clutch 150 is engaged and the torque output for motor 130 is zero. The continuously variable transmission 140 will adjust ratio to maintain the motor rpm as close to n4 as possible to prevent energy waste in over speeding the accessory 160.

When the user steps on the brake pedal, the motor 130 is used as generator to generate electricity. The system can manage braking force by controlling the current draw from the motor 130. The system can further manage the braking force by adjusting the rpm of the motor 130; the continuously variable transmission 140 can change ratio to allow motor 130 to spin at an rpm higher than n1 if needed.

There are other factors that may be included in deciding if motor 130, engine 110, or both are to be used as the source for torque; however, mode decision logics are often application specific, which is not the main subject in this embodiment.

If a CVT type transmission is used as the transmission 120, the main purpose of the continuously variable transmission 140 is to bridge the motor 130 and the engine 110 and to compensate the rpm difference of the motor 130 and the engine 110. The operation during electric mode and regenerative mode are essentially the same as if a manual transmission or an automatic transmission is used as the transmission 120.

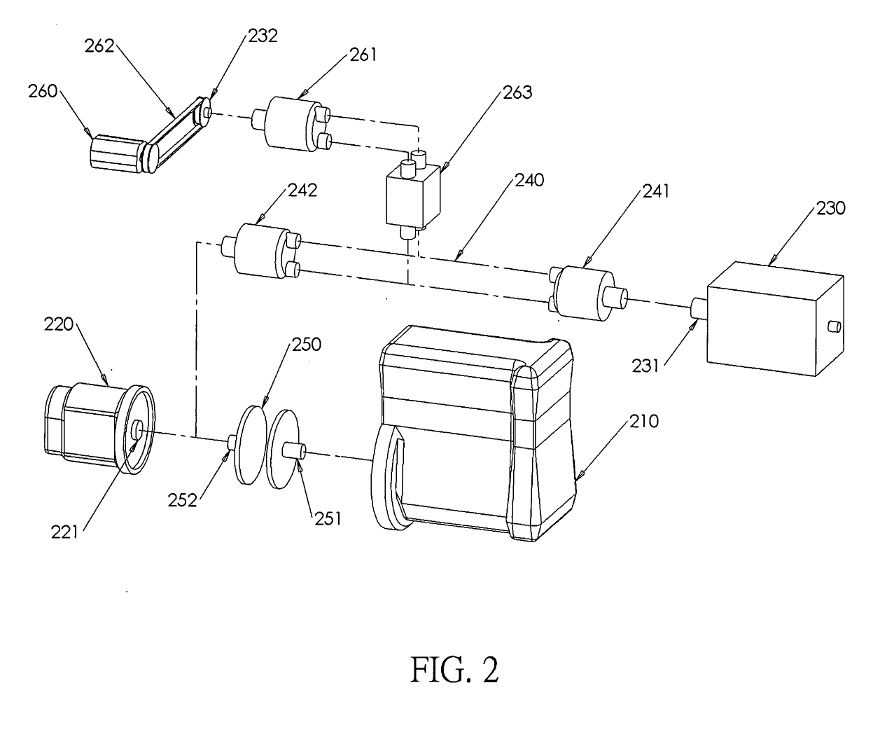

In a second embodiment consistent with the principles of the present invention, as shown in FIG. 2, the output shaft of the engine 210 is connected to the engine-side shaft 251 of the clutch 250. The transmission-side shaft 252 of the clutch 250 is connected to the input shaft 221 of the transmission 220. The transmission 220 mentioned herein is a complete transmission; if a manual transmission is used, a clutch would be included within the transmission casing, and if an automatic transmission is used, a torque converter would be included within the transmission casing. The rotor shaft 231 of the motor 230 is connected to motor-side unit 241 (also known as the first shaft) of the hydrostatic transmission 240. The transmission-side unit 242 (also known as the second shaft) of the hydrostatic transmission 240 is connected to the input shaft 221 of the transmission 220. A hydraulic motor 261 is connected to hydraulic lines between motor-side unit 242 and transmission-side unit 242; a directional switch 263 is included to ensure the hydraulic motor 261 always rotate in the same direction. An accessory pulley 232 is connected to the hydraulic motor 261. A belt 162 is connecting the accessory pulley 232 and accessory 260; accessory 260 mentioned herein represents any accessory that is used in automotive such as air conditioning compressor, power steering pump, water pump, air pump, vacuum pump or other accessories. A control system (not shown) is provided to control the clutch 250, the engine 210, and the motor 230.

Motor 230 and motor-side unit 241 can be located away from the engine 210 at rear or the mid section of the vehicle with hydraulic lines connecting between the motor-side unit 241 and the transmission-side unit 242. The transmission 220 can also incorporate the transmission-side unit 242 with the housing to further integrate with the hydrostatic transmission 240.

If a manual transmission or an automatic transmission is used as the transmission 220, the motor 230 is to be used in torque control mode. The maximum operational rpm for the motor 230 to provide torque is predetermined as n1. The minimum operational rpm for the motor 230 to power the accessory 260 is predetermined as n4. Two other rpm n2 and n3 are also predetermined between n1 and n4 wherein n2 is greater than n3.

Before user steps on the accelerator pedal, the rpm of motor 230 is maintained above n4. The clutch 250 is released thus disconnecting the engine-side shaft 251 and the transmission-side shaft 252. The engine 210 may be stopped to conserve fuel. The motor 230 spins the motor-side unit 242 to power the hydraulic pump 261. The accessory 260 is powered by hydraulic pump 261 via the belt 262 and accessory pulley 232.

When user steps on the accelerator pedal, the pedal angle is translated into a motor torque control signal which specifies the amount of torque that motor 230 should provide. As the motor 230 generates torque, the rpm of the motor 230 increases. When the rpm exceeds n2, the hydrostatic transmission 240 will change the ratio to provide more load on the motor-side unit 242 thus decrease the rpm of the motor 230.

If the rpm exceed n1, the torque of the motor 230 will be set to zero, and no longer generates torque. If the rpm of the motor 230 decrease below n3, the hydrostatic transmission 240 will also change to decrease the load on the motor-side unit 242 to decrease the load thus increase the rpm of the motor 230.

If the torque demanded by the user exceeds the ability of the motor 230, the system will enter hybrid mode, which both the engine 210 and the motor 230 will be used to provide torque. The clutch 250 will engage in a controlled manner, which spins the output shaft of the engine 210 and starts the engine 210.

During high speed cruise, the system will enter engine mode. The engine 210 will be used to provide torque. During engine mode, the clutch 250 is engaged and the torque output for motor 230 is zero. The hydraulic motor 261 will utilize the pressurized hydraulic fluid from the hydrostatic transmission 240 and powers the accessory 260. The directional switch 263 will ensure the direction of rotation of the hydraulic motor 261 stays the same.

When the user steps on the brake pedal, the motor 230 is used as generator to generate electricity. The system can manage braking force by controlling the current draw from the motor 230. The system can further manage the braking force by adjusting the rpm of the motor 230; the hydrostatic transmission 240 can change ratio to allow motor 230 to spin at an rpm higher than n1 if needed.

There are other factors that may be included in deciding if motor 230, engine 210, or both are to be used as the source for torque; however, mode decision logics are often application specific, which is not the main subject in this embodiment.

If a CVT type transmission is used as the transmission 220, the main purpose of the hydrostatic transmission 240 is to bridge the motor 230 and the engine 210 and to compensate the rpm difference of the motor 230 and the engine 210. The operation during electric mode and regenerative mode are essentially the same as if a manual transmission or an automatic transmission is used as the transmission 220.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A hybrid propulsion system comprising:
a) an engine provided with an output shaft;
b) a motor provided with a rotor shaft having a lower rpm range for producing torque and a higher rpm range for producing electricity;
c) a transmission provided with an input shaft;
d) a continuously variable transmission provided with a first shaft connected to the rotor shaft of the said motor and a second shaft connected to the input shaft of the said transmission; and,
e) a clutch connecting the output shaft of said engine and the second shaft of the said continuously variable transmission.

2. A hybrid propulsion system comprising:
a) an engine provided with an output shaft;
b) a motor provided with a rotor shaft;
c) a transmission provided with an input shaft;
d) a continuously variable transmission provided with a first shaft connected to the rotor shaft of the said motor and a second shaft connected to the input shaft of the said transmission;
e) a clutch connecting the output shaft of said engine and the second shaft of the said continuously variable transmission;
f) a engine accessory associated with the said rotor shaft of the said motor; and,
g) a control system to release said clutch, shut off said engine, and maintain rpm of said motor when the vehicle is stationary.

3. A hybrid propulsion comprising:
a) an engine provided with an output shaft;
b) a motor provided with a rotor shaft;
c) a transmission provided with an input shaft;
d) a hydrostatic transmission provided with a first shaft connected to the rotor shaft of the said motor and a second shaft connected to the input shaft of the said transmission;
e) a clutch connecting the output of the said engine and the said second shaft of the said hydrostatic transmission;
f) a hydraulic motor associated with said hydrostatic transmission;
g) an engine accessory associated with the said hydraulic motor;
h) a hydraulic switch associated with said hydraulic motor to prevent reversal of the said hydraulic motor; and,
i) a control system to release said clutch, shut off said engine, and maintain rpm of said motor when the vehicle is stationary.

4. A hybrid propulsion system as claimed in claim 1 wherein said transmission incorporates a clutch or torque converter within the said transmission in claim 1.

5. A hybrid propulsion system as claimed in claim 2 wherein said transmission incorporates a clutch or torque converter within the said transmission in claim 2.

6. A hybrid propulsion system as claimed in claim 2 wherein said engine accessory is an air conditioning compressor, a power steering pump, or an engine coolant pump.

7. A hybrid propulsion system as claimed in claim 2 wherein said engine accessory is connected to said rotor shaft of the said motor in claim 2 via a belt, chain, gear, or direct coupling.

8. A hybrid propulsion system as claimed in claim 2 wherein said continuously variable transmission enables the said motor to have a lower rpm than said engine when said engine is providing torque.

9. A hybrid propulsion system as claimed in claim 3 wherein the said motor is located rear of the front axle.

10. A hybrid propulsion system as claimed in claim 3 wherein said transmission incorporates a clutch or torque converter within the said transmission in claim 3

11. A hybrid propulsion system as claimed in claim 3 wherein said engine accessory is an air conditioning compressor, a power steering pump, or an engine coolant pump.

12. A hybrid propulsion system as claimed in claim 3 wherein said engine accessory is connected to said rotor shaft of the said hydraulic motor in claim 3 via a belt, chain, gear, or direct coupling.

13. A hybrid propulsion system as claimed in claim 3 wherein said hydrostatic transmission enables the said motor to have a lower rpm than said engine when said engine is providing torque.
